(19) United States
(12) Patent Application Publication
(10) Pub. No.: US 2009/0197216 A1
(43) Pub. Date: Aug. 6, 2009

(54) SELF-ADJUSTING ORTHODONTIC MODULE

(75) Inventor: Robert A. Miller, Clifton, VA (US)

Correspondence Address: AKIN GUMP STRAUSS HAUER & FELD, LLP, P O BOX 688, DALLAS, TX, 75313-0688, US

(73) Assignee: ROBERT A. MILLER DMD PC, Culpepper, VA (US)

(21) Appl. No.: 12/026,637

(22) Filed: Feb. 6, 2008

(51) Int. Cl. A61C 7/36

(52) U.S. Cl. 433/19

(57) ABSTRACT

An improved force module is used in orthodontic applications for treating patients with overbite or other dental problems. The improved force module may act as a force limiter to limit movement of a pushrod attached to either an archwire or bow and thereby limit a force generated by a spring attached to the pushrod. The improved force module is designed for use in an orthodontic system which self-adjusts, thus eliminating the need for routine adjustment. Also, the improved force module maintains its shape and strength for several months, may be made from a shape memory polymer, and may contain an embedded reinforcing wire or fiber.

### REFERENCE TO RELATED APPLICATIONS

Not applicable.

### TECHNICAL FIELD OF THE INVENTION

The present invention relates to orthodontic equipment used to treat patients with an overbite or other dental problems.

### BACKGROUND OF THE INVENTION

Orthodontic devices have generally been used for two reasons: (1) to move two or more teeth reciprocally or towards each other if a space exist with the intention of closing the space; and (2) to correct malocclusion by moving one dental arch as an entire unit in the opposite direction of another. In a Class II malocclusion (also referred to as an overbite problem) whereby the teeth meet incorrectly when chewing, the lower dental arch is behind the upper dental arch. Currently, many modules are available that are specifically designed to reduce this discrepancy or normalize this type of bite problem.

One problem with current modules is that they are typically made from materials which tend to break or lose their elasticity. Most of these existing materials tend to relax, fatigue, or break within 6-8 weeks.

Therefore, a need exists for an improved module that yields less creep or permanent stretch when stretched and relaxed many times.

### BRIEF SUMMARY OF THE INVENTION

An embodiment of the present invention improves the function of devices similar to the Forsus™ telescoping spring with archwire or X-Bow™ configurations. However, the present instant invention could also be used in a variety of other appliances and in a variety of different uses and embodiments without departing from the scope of the invention. Both of the aforementioned devices require activation or adjustment of the spring which corrects the bite problem or malocclusion every 4-8 weeks depending on the way the device is connected to the dental arches. These devices are used in conjunction with a Gurin lock which regulates the movement of a pushrod on the labial bow. An embodiment of the present invention is a module that can self-adjust to movement of at least one tooth of a patient without requiring activation or adjustment every 4-8 weeks. Specifically, the apparatus adjusts to the movement of at least one tooth of a patient. Therefore, the apparatus makes routine adjustment of the spring (e.g. every 4-8 weeks) unnecessary. In the past, adjustment of devices was necessary because as teeth move, the force on the bite correcting spring decreases and results in slowing down tooth movement.

In other words, the improved module acts as a force limiter. In this embodiment, every time the patient bites down, the desired force is created which moves the teeth from Class II malocclusion (bite problem) to Class I (normal bite). The desired force may be, for example, 200 grams. Movement of at least one tooth may occur in 4-6 months. With this self-adjusting module, however, less time will be required because it will require no adjustment. The instant invention, which uses a module as a force limiter, is an improvement over prior art devices which rely on a Gurin lock and must be routinely re-adjusted.

In addition, the improved module is stronger and more resilient to stretching. Unlike other modules which tend to relax, fatigue, and break, the improved module works for up to 6 months without needing replacement. The improved module may be made from a different material, may contain different dimensions, and may utilize an embedded wire or fiber to retain its strength and prevent stretching. Of course, any combination of the previous may be employed.

An embodiment of the present invention includes a method of using a module as a force limiter comprising: connecting a first end portion of the module to an anchor; and connecting a second end portion to a pushrod connected to a spring, wherein the module acts as a force limiter for a force produced by the spring and wherein the force is used to move at least one tooth.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a side view of a patient's mouth in which one embodiment of the instant invention is installed wherein a pushrod is connected to an archwire;

FIG. 2 is a representation of an improved force module illustrating an embedded reinforcing wire;

FIG. 3 is a side view of a patient's mouth showing another embodiment of the instant invention wherein the pushrod is connected to a bow;

FIG. 4 is a top view of the bottom teeth depicted in FIG. 3;

FIG. 5 is a top view of one embodiment of the improved force module wherein an end is clipped onto a microimplant ball;

FIG. 6 is a side view of the module represented in FIG. 5; and

FIG. 7 is another representation of an improved force module.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown but is to be accorded the widest scope consistent with the principles and features disclosed herein.

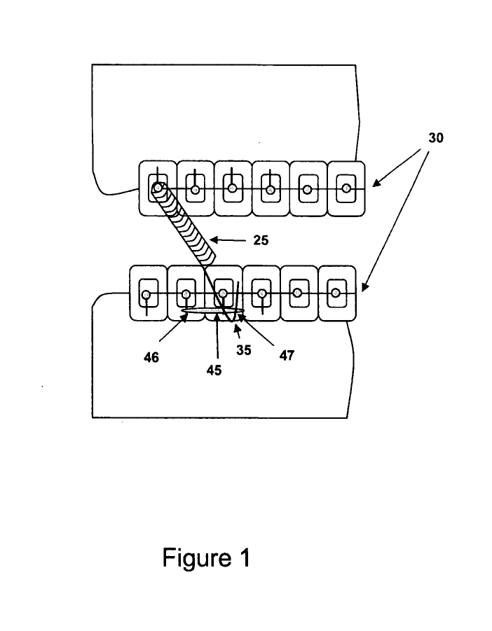

FIG. 1 depicts a side view of a patient's mouth in which one embodiment of the present invention has been installed. More specifically, a spring 25 such as, but not limited to, a Forsus™ Fatigue Resistant Device spring is utilized in this embodiment. The spring 25 has one end attached to at least one tooth on an upper dental arch. The other end of the spring 25 is attached to a first end of a pushrod 35 having two ends. The second end of the pushrod 35 may be connected or attached to an orthodontic support device in such a fashion that the second end of the pushrod 35 loops around the orthodontic support device allowing the pushrod to slide freely on the orthodontic support device. Orthodontic support devices include an archwire and a bow (such as an X-bow). An orthodontic support device typically extends around the outer surface of a patient's teeth. An archwire 30 is illustrated in FIG. 1 as a portion of the orthodontic support device which the pushrod 35 connects. In addition, a module 45 having two round ends is illustrated. The pushrod 35 extends through one of the round ends 47 of the module 45. The other end 46 of the module 45 is connected to a hook on a molar band. Thus, the hook on the molar band in this embodiment is an anchor for the module 45. The module 45 may be used as force limiter as taught in this application. Specifically, when a patient's teeth close together, the spring 25 compresses and pushes the pushrod 35 along the orthodontic support device (in this embodiment, the orthodontic support device is archwire 30). However, the module 45 acts as a force limiter to restrict the movement of the pushrod 35 along the archwire 30. In addition, the module 45 compresses when a patient's teeth open and expands when a patient's teeth close. Over time, the force from the spring 25 will move the whole lower segment of teeth forward, thereby curing a patient of overbite. Of course, the apparatus may be set to move one tooth or any number of teeth forward.

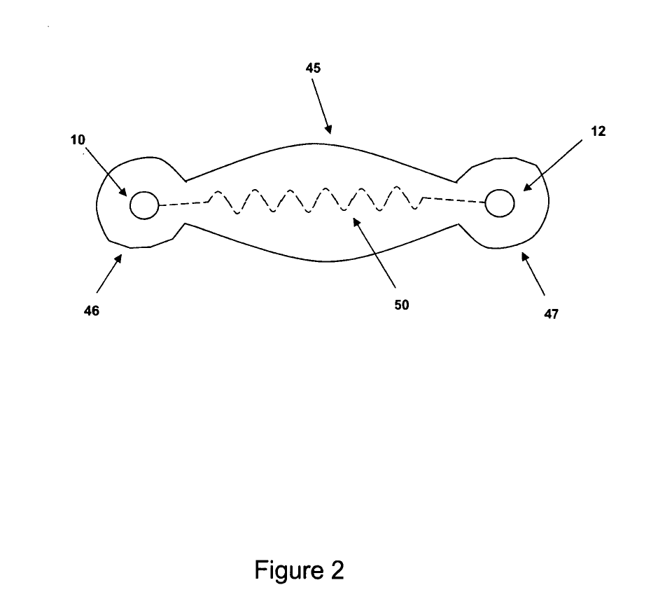

FIG. 2 is a top view of one example of a force limiting module 45. This module 45 has two round ends 46, 47. The module 45 also has an embedded reinforcing material 50. The embedded reinforcing material 50 may be a wire, spring, or fiber or other similar material. The function of embedded reinforcing material 50 is to limit the distance the module 45 stretches. This minimizes permanent deformation of the module 45 so it will maintain its shape for 4-6 months. Depending on the polymer used, the module 45 may stretch between 2-3 millimeters when the patient's teeth close and the spring 25 is compressed. This allows the pushrod 35 to slide 2-3 millimeters. Thus, the pushrod 35 slides along the archwire 30 the distance the module 45 is stretched. The module 45 has two round ends 46, 47 with holes 10, 12. However, the shape of the module 45 may be round, straight, or any variation in between that provides for stretching and rebounding to the original shape when relaxed.

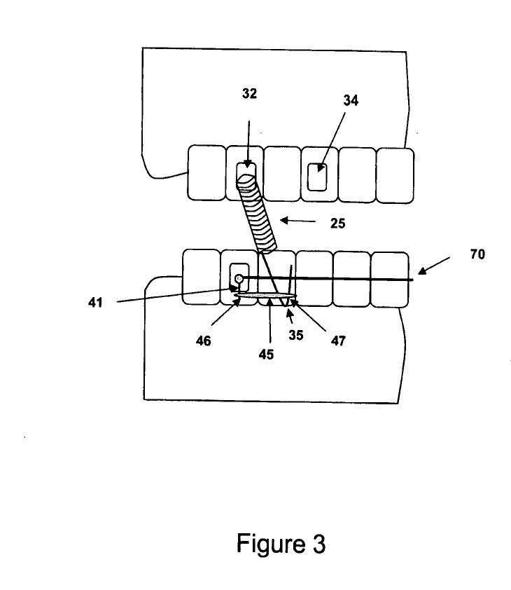

FIG. 3 depicts a side view of a patient's mouth showing another use of the invention. In this example, the patient does not have braces. In this embodiment, a spring 25, such as, but not limited to, a Forsus™ Fatigue Resistant Device is utilized in this embodiment as well. The spring 25 is attached to a first end of a pushrod 35. A second end of the pushrod 35 may be connected or attached to an orthodontic support device 32 in such a fashion that the second end of the pushrod 35 loops around the orthodontic support device 32 allowing the pushrod 35 to slide freely on the orthodontic support device 32. In this embodiment, a second tooth is also shown with a support device 34 and the orthodontic support device illustrated is a bow 70. The bow may be, but is not limited to, an X-bow. In addition, a module 45 having two round ends 46, 47 is utilized in this embodiment. The pushrod 35 extends through one of the round ends 47 of the module 45. The other end 46 of the module is connected to a hook 41 on a molar band. The hook 41 on the molar band 42 in this embodiment is the anchor for the module 45. Thus, the module 45 provides force limiting for the spring 25. The instant invention may be practiced when there are no brackets on any of the lower teeth (as in this embodiment), any of the upper teeth, or any of the upper or lower teeth.

In this embodiment, when a patient's teeth close together, the spring 25 compresses and pushes the pushrod 35 along the bow 70. The module 45 acts as a force limiter to restrict the movement of the pushrod 35 along the bow 70 and thus restricts the force applied by the spring 25. Again, the module 45 expands when a patient's teeth close and compresses when a patient's teeth open. Over time, the force from the spring 25 will move the lower segment of teeth forward, thereby curing a patient of overbite.

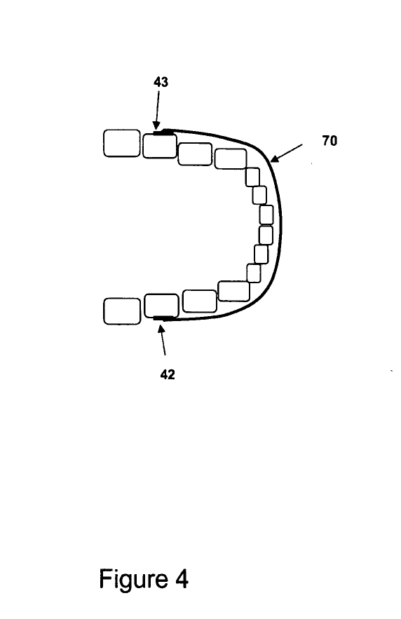

FIG. 4 illustrates a top view of the embodiment shown in FIG. 3. The bow 70 is connected to the lower teeth by two attachments 42, 43. The pushrod (shown in FIG. 3) moves along the bow 70 but is limited by the force limiter (shown in FIG. 3).

In another embodiment, one end of the module 45 could be mounted to a temporary anchorage device. A temporary anchorage device is usually installed in the jaw bone. The device provides an anchor to attach a module (such as the module contemplated by the present invention). For example, an end cap could be molded and a C-clip could be embedded in the end cap yielding a snap/quick disconnect for easy insertion and removal onto the ball end of a temporary anchorage device. This end cap and C-clip could be fabricated in many different dimensions depending on the specific size of the ball cap of the temporary anchorage device.

For example, the temporary anchorage device may be a microimplant ball. One example is the Imtek microimplant ball.

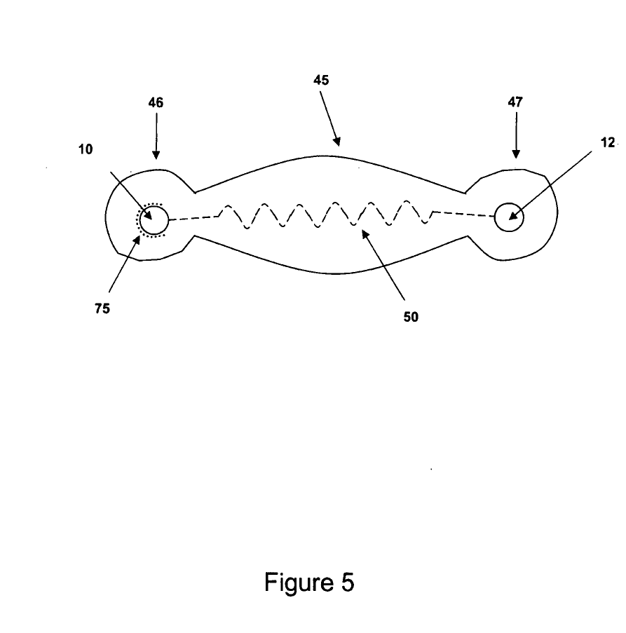

FIG. 5 is a top view of one embodiment of a module 45 wherein the anchoring end of the module 45 may clip onto a microimplant ball (not shown). The module 45 in this embodiment contains a C-clip 75 adjacent to the hole 10 on one round end 46 for mounting onto a microimplant ball. In addition, the other end 47 and corresponding hole 12 are also shown. Moreover, the longitudinal middle portion of the module 45 could be fabricated in various lengths to vary the force between 50-150 grams. Moreover, in this embodiment, the module 45 contains an embedded reinforcing material 50. Of course, other embodiments could omit the embedded reinforcing material 50.

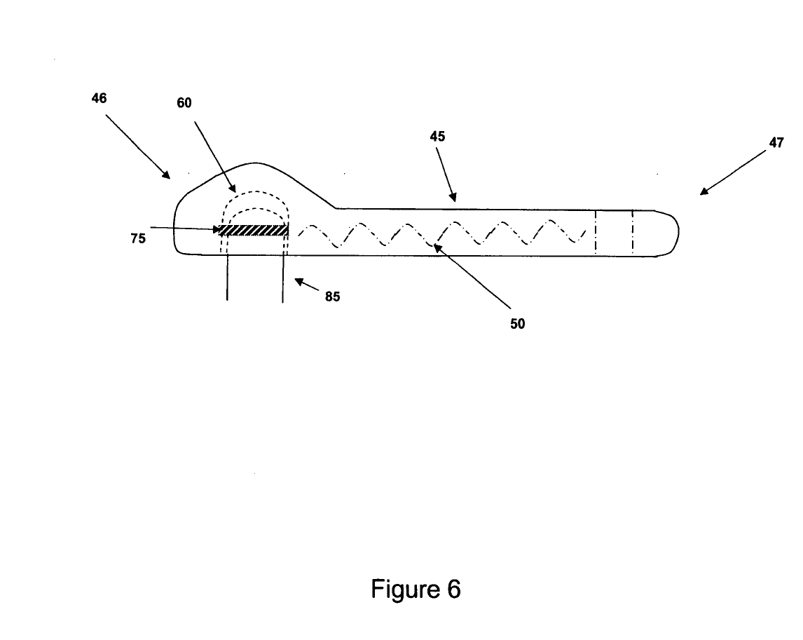

FIG. 6 is a side view of a particular embodiment of the module 45 represented in FIG. 4. In this embodiment, the C-clip 75 is attached to a microimplant 85 for anchorage. The microplant 85 slips into a chamber 60 in one 46 of the ends and clips on the C-clip 75. In addition, the embedded reinforcing material 50 and the other end 47 of the module 45 are also shown. The embedded reinforcing material 50 could be made of various materials. For example, the embedded reinforcing material 50 could be a nickel titanium spring embedded in the center of the longitudinal round section of the elastomer. This would limit the length and creep as previously described, but also would provide a consistent (same number of grams) and continuous force, when stretched. In addition, this material would optimize tooth movement. Additionally, encasing the spring in an elastomeric or other type of compound would make it easier to keep the spring clean since springs tend to collect plaque and food. Thus, the device would be more hygienic.

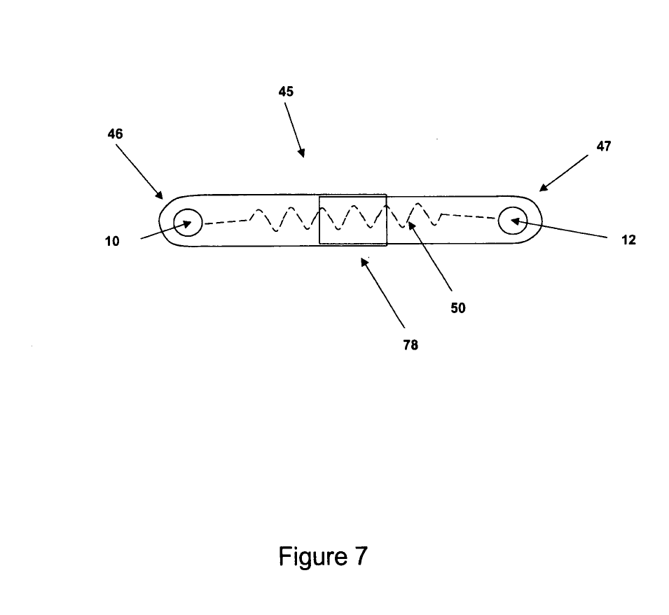

FIG. 7 is a top view of another example of a force limiting module 45. This module 45 has two round ends 46, 47 with respective holes 10, 12. The module 45 also has an embedded reinforcing material 50. The embedded reinforcing material 50 may be a wire, spring, or fiber. However, in this embodiment, the module 45 is comprised of two telescoping parts that overlap in an area 78. This embodiment of the module 45 may be comprised of more rigid parts since it overlaps and lengthens when the module 45 is stretched and compacts when at rest.

In another embodiment, the module 45 could be implemented around the bracket of regular braces. There are many differences other modules and the module illustrated in the embodiments. One difference is the design. The module 45 utilizes any number of or all of the following: a different material, different dimensions, and an embedded wire. Another difference is the use. Unlike other modules, the module 45 acts as a force limiter. Accordingly, the module 45 is utilized in an orthodontic system such that the module 45 compresses when a patient's mouth opens and expands when a patient's mouth closes. In contrast, other modules are utilized in an orthodontic system such that the modules compress when a patient's mouth closes and expand when a patient's mouth opens.

Polymers which may be appropriate for the module 45 include a shape memory polymer such as polynorbornen or polynorbornene. Shape memory polymers are desirable for use in the module 45 because they can be shaped to allow a consistent force when stretched and relaxed. Existing elastomers are not well suited in this capacity because most of the existing materials relax, fatigue and/or break within 6-8 weeks. However, polynorbornen and polynorbornene are well suited for the module 45 because they provide minimal creep (less than 5%) and last 4-6 months. In addition, the module 45 may have a different diameter or length from other current modules. Moreover, the module 45 may be reinforced with a length limiting wire that will prevent creep and limit stretch beyond, for example, 2-3 millimeters. In another embodiment, the reinforcing material could be modified to increase the length of the module, thus broadening its application to be used as a force module to move teeth or groups of teeth towards a microimplant or temporary anchorage device.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. For example, the hybrid server and storage array may be implemented in a small box that is artistic and may be mountable on a wall. Thus, the present invention is not intended to be limited to the embodiments shown herein but is to be accorded the widest scope consistent with the principles and novel features disclosed herein.

What is claimed is:

1. A method of using a module as a force limiter comprising:
connecting a first end portion of the module to an anchor wherein the module comprises an embedded spring; and
connecting a second end portion to a pushrod connected to a spring, wherein the module acts as a force limiter for a force produced by the spring and wherein the force is used to move at least one tooth.

2. The method of claim 1, wherein the module acts as a force limiter when a patient's teeth close.

3. The method of claim 1, wherein the module is a made of a shape memory polymer.

4. The method of claim 1, wherein the anchor is a hook.

5. The method of claim 4, wherein the hook is on a molar band.

6. The method of claim 1, wherein the anchor is a temporary anchorage device.

7. The method of claim 6, wherein the temporary anchorage device is a microimplant ball.

8. The method of claim 1, wherein the module contracts when a patient's teeth open.

9. The method of claim 1, wherein the module expands when a patient's teeth close.

10. An improved force module for correcting dental problems comprising:
a first end portion able to connect to an anchor;
a second end portion able to connect to a pushrod;
a shaft portion interposed between the first end portion and the second portion; and
a reinforcing spring embedded within the shaft portion.

11. The improved force module of claim 10, wherein the reinforcing spring limits the length the module is able to expand.

12. An orthodontic apparatus for moving at least one tooth comprising:
a spring having one end connected to a pushrod and another end connected to one upper tooth; and
a module comprising an embedded reinforcing spring wherein the module has a first end connected to an anchor, wherein the module also has a second end connected to the pushrod and the pushrod has a first end is connected to the module and a second end connected to an orthodontic support device; wherein the pushrod slides along the orthodontic support device when the module stretches; and wherein the spring applies a force to move the at least one tooth.

13. The apparatus of claim 12, wherein the orthodontic support device is an archwire.

14. The apparatus of claim 12, wherein the orthodontic support device is a bow.

15. The apparatus of claim 12, wherein the anchor is a hook.

16. The apparatus of claim 12, wherein the anchor is a microimplant ball.

17. The apparatus of claim 12, wherein the module acts as a force limiter.

18. The apparatus of claim 12, wherein the apparatus is used to treat patients with overbite.

19. The apparatus of claim 12, wherein the module is made from a shape memory polymer.
